(19) United States
(12) Patent Application Publication
(10) Pub. No.: US 2021/0191200 A1
(43) Pub. Date: Jun. 24, 2021

(54) LIQUID CRYSTAL CELL AND SELF-LUMINOUS DISPLAY DEVICE

(71) Applicant: SHENZHEN CHINA STAR OPTOELECTRONICS SEMICONDUCTOR DISPLAY TECHNOLOGY CO., LTD., Shenzhen (CN)

(72) Inventors: Zhiqing SHI, Shenzhen, Guangdong (CN); Galatu SURI, Shenzhen, Guangdong (CN); Zhengyu FENG, Shenzhen, Guangdong (CN)

(21) Appl. No.: 16/754,451

(22) PCT Filed: Dec. 26, 2019
(86) PCT No.: PCT/CN2019/128636

§ 371 Date: Apr. 8, 2020

(30) Foreign Application Priority Data
Dec. 18, 2019 (CN) 201911307709.5

(51) Int. Cl. G02F 1/1337; G02F 1/1335

(52) U.S. Cl. CPC G02F 1/133723; G02F 1/133626

(57) ABSTRACT

The present application discloses a liquid crystal cell and a self-luminous display device. The present application realizes that the liquid crystal cell is switched between a transparent state and a non-transparent state. Transparent display devices with liquid crystal cells can better output panel information in the non-transparent state and can also realize effects of transparency of the transparent display devices in the transparent state, which further expands application scenarios of the transparent display devices.

### CROSS-REFERENCE TO RELATED APPLICATIONS

This application claims the priority to Chinese Patent Application No. 201911307709.5, entitled “LIQUID CRYSTAL CELL AND SELF-LUMINOUS DISPLAY DEVICE” and filed on Dec. 18, 2019 with the State Intellectual Property Office of the People's Republic of China, which is entirely incorporated by reference into the present application.

### FIELD OF APPLICATION

The present application is related to the field of display technology, and specifically to a liquid crystal cell and a self-luminous display device.

### BACKGROUND OF APPLICATION

Transparent display technology, which is an emerging display technology, can bring more novel visual experiences to consumers. During an operation of a transparent display device, users can see not only contents displayed on a panel but also objects behind the panel through the panel. Transparent display devices can be integrated with technologies such as multi-touch and intelligent display to be terminals for public information display. They are used in various fields such as department store display windows, refrigerator doors, bus stations, automobile windshields, and vending machines, which have a broad market prospect.

### SUMMARY OF APPLICATION

Currently, mini light-emitting diodes (Mini LEDs) or micro light-emitting diodes (Micro LEDs), which are potential next-generation display technologies, have attracted widespread attention. Transparent display devices based on liquid crystal displays (LCDs) or organic light-emitting diodes (OLEDs) have been extensively researched, but the transparent display devices have limited uses and poor display effects in many application scenarios.

The present application provides a liquid crystal cell, which can realize that the liquid crystal cell is switched between a transparent state and a non-transparent state. Transparent display devices with liquid crystal cells can better output panel information in the non-transparent state and can also realize effects of transparency of the transparent display devices in the transparent state, which provides technical solutions to expands the application scenarios of the transparent display devices.

In order to solve the above problems, in a first aspect, the present application provides the liquid crystal cell including a first alignment film, a second alignment film, a first conductive glass substrate, and a second conductive glass substrate.

The first conductive glass substrate and the second conductive glass substrate are oppositely disposed and constitute a closed space. The first alignment film is disposed on a side of the first conductive glass substrate away from the second conductive glass substrate. The second alignment film is disposed on a side of the second conductive glass substrate away from the first conductive glass substrate. The closed space is filled with a mixed solution including liquid crystal molecules and dichroic dye molecules.

The dichroic dye molecules are vertically deflected with the liquid crystal molecules when a driving voltage is applied between the first alignment film and the second alignment film. The dichroic dye molecules are aligned parallel to the first conductive glass substrate with the liquid crystal molecules when no driving voltage is applied between the first alignment film and the second alignment film.

Furthermore, a proportion of the dichroic dye molecules in the mixed solution ranges from 0.5 to 10 wt %.

Furthermore, the mixed solution further includes an organic solvent.

Furthermore, the first conductive glass substrate is an indium tin oxide (ITO) conductive glass substrate.

Furthermore, the first alignment film and the second alignment film are polyimide films.

Furthermore, the first alignment film and the second alignment film are respectively a parallel alignment film and a vertical alignment film.

Furthermore, alignment directions of the first alignment film and the second alignment film form an included angle therebetween, and the included angle ranges from 0 to 180 degrees.

In a second aspect, the present application provides a self-luminous display device including a driving circuit, a self-luminous display panel, and a liquid crystal cell. The driving circuit is configured to apply a driving voltage between a first alignment film and a second alignment film. The self-luminous display panel is a transparent self-luminous display panel. The liquid crystal cell is disposed opposite to the self-luminous display panel and disposed behind the self-luminous display panel.

The liquid crystal cell includes the first alignment film, the second alignment film, a first conductive glass substrate, and a second conductive glass substrate.

The first conductive glass substrate and the second conductive glass substrate are oppositely disposed and constitute a closed space. The first alignment film is disposed on a side of the first conductive glass substrate away from the second conductive glass substrate. The second alignment film is disposed on a side of the second conductive glass substrate away from the first conductive glass substrate. The closed space is filled with a mixed solution including liquid crystal molecules and dichroic dye molecules.

The dichroic dye molecules are vertically deflected with the liquid crystal molecules when a driving voltage is applied between the first alignment film and the second alignment film. The dichroic dye molecules are aligned parallel to the first conductive glass substrate with the liquid crystal molecules when no driving voltage is applied between the first alignment film and the second alignment film.

Furthermore, a proportion of the dichroic dye molecules in the mixed solution ranges from 0.5 to 10 wt %.

Furthermore, the mixed solution further includes an organic solvent.

Furthermore, the first conductive glass substrate is an indium tin oxide (ITO) conductive glass substrate.

Furthermore, the first alignment film and the second alignment film are polyimide films.

Furthermore, the first alignment film and the second alignment film are respectively a parallel alignment film and a vertical alignment film.

Furthermore, alignment directions of the first alignment film and the second alignment film form an included angle therebetween, and the included angle ranges from 0 to 180 degrees.

Furthermore, the liquid crystal cell includes a transparent region. An area of the transparent region of the liquid crystal cell is equal to an area of a display region of the self-luminous display panel.

Furthermore, the self-luminous display panel includes a mini light-emitting diode display panel, a micro light-emitting diode display panel, or an organic light-emitting diode display panel.

The present application provides the liquid crystal cell. The liquid crystal cell includes the first alignment film, the second alignment film, the first conductive glass substrate, and the second conductive glass substrate. The first conductive glass substrate and the second conductive glass substrate are oppositely disposed and constitute the closed space. The first alignment film is disposed on the side of the first conductive glass substrate away from the second conductive glass substrate. The second alignment film is disposed on the side of the second conductive glass substrate away from the first conductive glass substrate. The closed space is filled with the mixed solution including the liquid crystal molecules and the dichroic dye molecules. The dichroic dye molecules are vertically deflected with the liquid crystal molecules when the driving voltage is applied between the first alignment film and the second alignment film, and the liquid crystal cell is in the transparent state. The dichroic dye molecules are aligned parallel to the first conductive glass substrate with the liquid crystal molecules when no driving voltage is applied between the first alignment film and the second alignment film, and the liquid crystal cell is in the non-transparent state. Therefore, switching of the liquid crystal cell between the transparent state and the non-transparent state is realized. The transparent display devices with the liquid crystal cells can better output the panel information in the non-transparent state and can also realize the effects of transparency of the transparent display devices in the transparent state, which further expands the application scenarios of the transparent display devices.

### DESCRIPTION OF DRAWINGS

In order to describe technical solutions in the present application clearly, drawings to be used in the description of embodiments will be described briefly below. Obviously, drawings described below are only for some embodiments of the present application, and other drawings may be obtained by those skilled in the art based on these drawings without creative efforts.

FIG. 1 is a structural diagram of a liquid crystal cell provided by an embodiment the present application.

FIG. 2 is a structural diagram of a self-luminous display device provided by an embodiment the present application.

### DETAILED DESCRIPTION OF PREFERRED EMBODIMENTS

To further explain the technical means and effect of the present application, the following refers to embodiments and drawings for detailed description. Obviously, the described embodiments are only for some embodiments of the present application, instead of all embodiments. Based on the embodiments of the present application, all other embodiments obtained by those skilled in the art without creative work fall into a protection scope of the present application.

Directional terms mentioned in the present application, such as upper, lower, front, rear, left, right, in, out, side, etc., only refer to directions in the accompanying drawings. Thus, the adoption of directional terms is used to describe and understand the present application, but not to limit the present application. In addition, the terms “first” and “second” are merely used for illustrative purposes only, but are not to be construed as indicating or imposing a relative importance or implicitly indicating the number of technical features indicated. Thus, a feature that defines “first” or “second” may expressly or implicitly include one or more of the features. In the description of the present application, the meaning of “plural” is two or more, unless otherwise specified.

Currently, transparent display devices based on liquid crystal displays (LCDs) or organic light-emitting diodes (OLEDs) have been extensively researched, but the transparent display devices based on mini light-emitting diodes (Mini LEDs) or micro light-emitting diodes (Micro LEDs) have not been researched much, and their application scenarios are limited.

Therefore, the present application provides a liquid crystal cell and a self-luminous display device, which are respectively described in detail below.

First, the present application provides the liquid crystal cell including a first alignment film, a second alignment film, a first conductive glass substrate, and a second conductive glass substrate.

The first conductive glass substrate and the second conductive glass substrate are oppositely disposed and constitute a closed space. The first alignment film is disposed on a side of the first conductive glass substrate away from the second conductive glass substrate. The second alignment film is disposed on a side of the second conductive glass substrate away from the first conductive glass substrate. The closed space is filled with a mixed solution including liquid crystal molecules and dichroic dye molecules.

Specifically, the liquid crystal molecules and the dichroic dye molecules are uniformly mixed, and the dichroic dye molecules are uniformly distributed in the mixed solution.

The dichroic dye molecules are vertically deflected with the liquid crystal molecules when a driving voltage is applied between the first alignment film and the second alignment film. The dichroic dye molecules are aligned parallel to the first conductive glass substrate with the liquid crystal molecules when no driving voltage is applied between the first alignment film and the second alignment film.

Specifically, the dichroic dye molecules do not have polarity, so that they can move with movements of the liquid crystal molecules.

Specifically, the dichroic dye molecules are used to absorb light, and a visible light absorption spectrum of the dichroic dye molecules ranges from 400 to 780 nanometers.

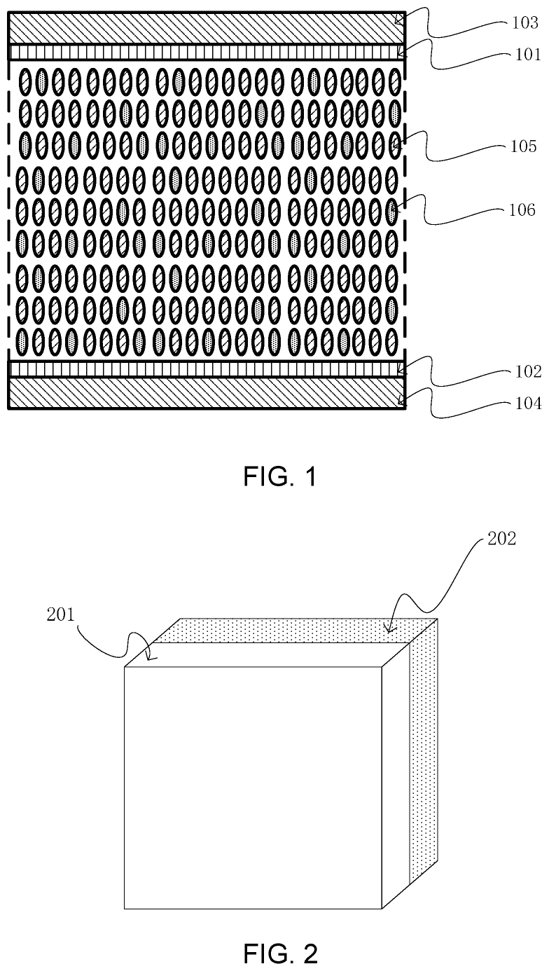

As shown in FIG. 1, which is a structural diagram of the liquid crystal cell provided by an embodiment the present application, the liquid crystal cell includes the first alignment film 101, the second alignment film 102, the first conductive glass substrate 103, and the second conductive glass substrate 104.

The first conductive glass substrate 103 and the second conductive glass substrate 104 are oppositely disposed and constitute the closed space. The first alignment film 101 is disposed on the side of the first conductive glass substrate 103 away from the second conductive glass substrate 104. The second alignment film 102 is disposed on the side of the second conductive glass substrate 104 away from the first conductive glass substrate 103. The closed space is filled with the mixed solution including the liquid crystal molecules 105 and the dichroic dye molecules 106.

The first alignment film 101 is a parallel alignment film, and the second alignment film 102 is a vertical alignment film.

As shown in FIG. 1, the dichroic dye molecules 106 are vertically deflected with the liquid crystal molecules 105 when the driving voltage is applied between the first alignment film 101 and the second alignment film 102. The dichroic dye molecules 106 are aligned parallel to substrates with the liquid crystal molecules 105 when no driving voltage is applied between the first alignment film 101 and the second alignment film 102.

Specifically, the dichroic dye molecules 106 are vertically deflected with the liquid crystal molecules 105 when the driving voltage is applied between the first alignment film 101 and the second alignment film 102. At this time, there are gaps between the vertically deflected liquid crystal molecules 105 and the dichroic dye molecules 106 when light irradiates the liquid crystal cell, so that the light can pass through the liquid crystal cell, and the liquid crystal cell is in a transparent state at this time.

The dichroic dye molecules 106 are aligned parallel to the substrates with the liquid crystal molecules 105 when the driving voltage applied between the first alignment film 101 and the second alignment film 102 is stopped. At this time, there are no gaps between the liquid crystal molecules 105 and the dichroic dye molecules 106. When the light passes through the liquid crystal cell, the liquid crystal molecules 105 which are deflected and aligned parallel to the substrates block the visible light, the dichroic dye molecules 106 absorb the visible light, and the liquid crystal cell is in a non-transparent state at this time.

In the liquid crystal cell provided by the present application, the dichroic dye molecules are vertically deflected with the liquid crystal molecules when the driving voltage is applied between the first alignment film and the second alignment film, and the liquid crystal cell is in the transparent state. The dichroic dye molecules are aligned parallel to the first conductive glass substrate with the liquid crystal molecules when no driving voltage is applied between the first alignment film and the second alignment film, and the liquid crystal cell is in the non-transparent state. Therefore, switching of the liquid crystal cell between the transparent state and the non-transparent state is realized. The transparent display devices with liquid crystal cells can better output panel information in the non-transparent state and can also realize effects of transparency of the transparent display devices in the transparent state, which further expands the application scenarios of the transparent display devices.

Based on the above embodiments, in another embodiment of the present application, a proportion of the dichroic dye molecules in the mixed solution ranges from 0.5 to 10 wt %.

Specifically, when the proportion of the dichroic dye molecules in the mixed solution ranges from 0.5 to 10 wt %, requirements of the present application are implemented, and a specific proportion is not limited herein.

Based on the above embodiments, in another embodiment of the present application, the mixed solution further includes an organic solvent such as chloroform. The present application does not limit the organic solvent, and it should be determined according to specific conditions.

Generally, in order to make the dichroic dye molecules and the liquid crystal molecules mix with each other better, the organic solvent can be added to effectively make the dichroic dye molecules uniformly distributed in the mixed solution.

Based on the above embodiments, in another embodiment of the present application, the first conductive glass substrate can be an indium tin oxide (ITO) conductive glass substrate. The present application does not limit the ITO conductive glass substrate, and it should be determined according to specific conditions.

Based on the above embodiments, in another embodiment of the present application, the first alignment film and the second alignment film are polyimide films.

Specifically, polyimide refers to a polymer containing an imide ring (—CO—NH—CO—) in a main chain, and a polymer containing a phthalimide structure is the most important. As a special engineering material, the polyimide has been widely used in aviation, aerospace, microelectronics, nanometer, liquid crystal, separation membrane, laser, and other fields. Because of the outstanding characteristics of polyimide in performance and synthesis, whether as a structural material or a functional material, its performance has been widely recognized.

Based on the above embodiments, in another embodiment of the present application, the first alignment film and the second alignment film are respectively the parallel alignment film and the vertical alignment film.

Specifically, the first alignment film and the second alignment film only need to satisfy that they are both the parallel alignment film and the vertical alignment film, which is not limited herein.

Based on the above embodiments, in another embodiment of the present application, alignment directions of the first alignment film and the second alignment film form an included angle therebetween, and the included angle ranges from 0 to 180 degrees.

In order to better deflect liquid crystal molecules, deflection efficiency of the liquid crystal molecules can be increased by forming the parallel alignment film and the vertical alignment film with a certain pretilt angle.

In order to better implement the liquid crystal cell in the embodiment of the present application, on a basis of the liquid crystal cell, the present application further provides the self-luminous display device including a driving circuit, a self-luminous display panel, and a liquid crystal cell. The driving circuit is configured to apply a driving voltage between a first alignment film and a second alignment film.

Generally, the self-luminous display panel does not require a backlight source. Material of the self-luminous display panel is a transparent material, so that a transparent display can be realized.

The self-luminous display panel is a transparent self-luminous display panel. The liquid crystal cell is disposed opposite to the self-luminous display panel and disposed behind the self-luminous display panel.

As shown in FIG. 2, which is a structural diagram of the self-luminous display device provided by an embodiment the present application, the self-luminous display device includes the driving circuit, the self-luminous display panel 201, and the liquid crystal cell 202. The driving circuit is configured to apply the driving voltage between the first alignment film and the second alignment film.

The self-luminous display panel 201 is the transparent self-luminous display panel. The liquid crystal cell 302 is disposed opposite to the self-luminous display panel 201 and disposed behind the self-luminous display panel 201.

By adopting the self-luminous display device described in the above embodiment, the self-luminous display panel is combined with the liquid crystal cell, so that a background of the self-luminous display can be switched between the transparent state and the non-transparent state, which further expands the application scenarios of the transparent display devices.

Based on the above embodiments, in another embodiment of the present application, the liquid crystal cell includes a transparent region. An area of the transparent region of the liquid crystal cell is equal to an area of a display region of the self-luminous display panel.

Based on the above embodiments, in another embodiment of the present application, the self-luminous display panel can be a mini light-emitting diode display panel, a micro light-emitting diode display panel, or an organic light-emitting diode display panel, which is not limited herein.

Based on the above embodiments, in another embodiment of the present application, a proportion of the dichroic dye molecules in the mixed solution ranges from 0.5 to 10 wt %.

Based on the above embodiments, in another embodiment of the present application, the mixed solution further includes an organic solvent.

Based on the above embodiments, in another embodiment of the present application, the first conductive glass substrate is an indium tin oxide (ITO) conductive glass substrate.

Based on the above embodiments, in another embodiment of the present application, the first alignment film and the second alignment film are polyimide films.

Based on the above embodiments, in another embodiment of the present application, the first alignment film and the second alignment film are respectively a parallel alignment film and a vertical alignment film.

Based on the above embodiments, in another embodiment of the present application, alignment directions of the first alignment film and the second alignment film form an included angle therebetween, and the included angle ranges from 0 to 180 degrees.

In the above embodiments, the description of each embodiment has its own emphasis. For a part that is not described in detail in one embodiment, reference may be made to related descriptions in other embodiments.

In a specific implementation, each of the above units or structures may be implemented as independent entities, or any combination may be implemented as the same or several entities. For the specific implementation of the above units or the structures, refer to the foregoing method embodiments, and details are not further described herein.

For a specific implementation of the foregoing operations, refer to the foregoing embodiments, and details are not further described herein.

The liquid crystal cell and the self-luminous display device provided according to the embodiments of the present application have been described in detail above, and the principles and implementations of the present application are set forth herein by applying specific examples, and the description of the above embodiments is merely used to help to understand the method and core idea of the present application. Meanwhile, for a person of ordinary skill in the art, according to the concept of the present application, changes will be made to the specific implementations and application ranges, and in summary, the contents of the present description should not be construed as limiting the present application.

1. A liquid crystal cell, comprising:
a first alignment film, a second alignment film, a first conductive glass substrate, and a second conductive glass substrate;
wherein an alignment direction of the first alignment film and an alignment direction of the second alignment film form an included angle, and the included angle ranges from 0 to 180 degrees;
wherein the first conductive glass substrate and the second conductive glass substrate are oppositely disposed and constitute a closed space, the first alignment film is disposed on a side of the first conductive glass substrate facing the second conductive glass substrate, the second alignment film is disposed on a side of the second conductive glass substrate facing the first conductive glass substrate, and the closed space is filled with a mixed solution comprising liquid crystal molecules and dichroic dye molecules; and
wherein the dichroic dye molecules are vertically deflected with the liquid crystal molecules when a driving voltage is applied between the first alignment film and the second alignment film, and the dichroic dye molecules are aligned parallel to the first conductive glass substrate with the liquid crystal molecules when no driving voltage is applied between the first alignment film and the second alignment film.

2. The liquid crystal cell according to claim 1, wherein a proportion of the dichroic dye molecules in the mixed solution ranges from 0.5 to 10 wt %.

3. The liquid crystal cell according to claim 1, wherein the mixed solution further comprises an organic solvent.

4. The liquid crystal cell according to claim 1, wherein the first conductive glass substrate is an indium tin oxide (ITO) conductive glass substrate.

5. The liquid crystal cell according to claim 1, wherein the first alignment film and the second alignment film are polyimide films.

6. The liquid crystal cell according to claim 1, wherein the first alignment film and the second alignment film are respectively a parallel alignment film and a vertical alignment film.

7. (canceled)

8. A self-luminous display device, comprising:
a driving circuit, a self-luminous display panel, and a liquid crystal cell;
wherein the driving circuit is configured to apply a driving voltage between a first alignment film and a second alignment film, the self-luminous display panel is a transparent self-luminous display panel, and the liquid crystal cell is disposed opposite to the self-luminous display panel and disposed behind the self-luminous display panel;
wherein the liquid crystal cell comprises the first alignment film, the second alignment film, a first conductive glass substrate, and a second conductive glass substrate;
wherein an alignment direction of the first alignment film and an alignment direction of the second alignment film form an included angle, and the included angle ranges from 0 to 180 degrees;
wherein the first conductive glass substrate and the second conductive glass substrate are oppositely disposed and constitute a closed space, the first alignment film is disposed on a side of the first conductive glass substrate facing the second conductive glass substrate, the second alignment film is disposed on a side of the second conductive glass substrate facing the first conductive glass substrate, and the closed space is filled with a mixed solution comprising liquid crystal molecules and dichroic dye molecules; and
wherein the dichroic dye molecules are vertically deflected with the liquid crystal molecules when the driving voltage is applied between the first alignment film and the second alignment film, and the dichroic dye molecules are aligned parallel to the first conductive glass substrate with the liquid crystal molecules when no driving voltage is applied between the first alignment film and the second alignment film.

9. The self-luminous display device according to claim 8, wherein a proportion of the dichroic dye molecules in the mixed solution ranges from 0.5 to 10 wt %.

10. The self-luminous display device according to claim 8, wherein the mixed solution further comprises an organic solvent.

11. The self-luminous display device according to claim 8, wherein the first conductive glass substrate is an indium tin oxide (ITO) conductive glass substrate.

12. The self-luminous display device according to claim 8, wherein the first alignment film and the second alignment film are polyimide films.

13. The self-luminous display device according to claim 8, wherein the first alignment film and the second alignment film are respectively a parallel alignment film and a vertical alignment film.

14. (canceled)

15. The self-luminous display device according to claim 8, wherein the liquid crystal cell comprises a transparent region, and an area of the transparent region of the liquid crystal cell is equal to an area of a display region of the self-luminous display panel.

16. The self-luminous display device according to claim 8, wherein the self-luminous display panel comprises a mini light-emitting diode display panel, a micro light-emitting diode display panel, or an organic light-emitting diode display panel.
